(19) United States
(12) Patent Application Publication
(10) Pub. No.: US 2003/0082979 A1
(43) Pub. Date: May 1, 2003

(54) Pulp and conjugate glass fiber composite with enhanced stiffness and permeability

(75) Inventors: Karen Hargett Bean, Cumming, GA (US); David Lewis Myers, Cumming, GA (US); Ganesh Chandra Deka, Duluth, GA (US); Bruce George Stokes, Woodstock, GA (US); Jerry Wayne Estes, Marietta, GA (US)

Correspondence Address: William W. Letson, Kimberly-Clark Worldwide, Inc., Patent Department, 401 North Lake Street, Neenah, WI, 54956, US

(73) Assignee: Kimberly-Clark Worldwide, Inc.

(21) Appl. No.: 09/999,741

(22) Filed: Oct. 31, 2001

(51) Int. Cl. D04H 1/00; D04H 3/00; D04H 5/00; D04H 13/00; B32B 5/26

(52) U.S. Cl. 442/361; 442/381; 442/362; 442/363; 442/364; 442/352

(57) ABSTRACT

The present invention relates to a composite which is capable of use as a filter medium and a method for producing the same. The composite may include pulp fibers and conjugate glass fibers. The conjugate fibers are desirably composed of at least two glasses which have different thermal expansion properties. The difference in thermal expansion coefficients of the multicomponent fiber produces a fiber with a random helical crimp. The random helical crimp of the conjugate fibers reduces the packing efficiency of the glass itself and the other fibers. The reduced packing efficiency affords the opportunity to prepare pulp/conjugate glass fiber composite materials with higher porosity and higher permeability for a given basis weight. The addition of the polyester staple fibers to the composite lends sufficient stiffness to the web so as to allow pleating without further treatment such as with a binder material.

### BACKGROUND OF THE INVENTION

The present invention is related to a filter medium for fluids, and more particularly related to a wet-laid composite highly suitable for fluid filter media.

Different types of nonwoven webs have been used as filter media for various liquid and gas filtration applications, and such nonwoven webs include meltblown fiber webs, solution spun fiber webs, wet-laid fiber webs, carded fiber webs, air-laid fiber webs and spunbond fiber webs (e.g. needled felts). Of these nonwoven fiber webs, microfiber nonwoven webs, such as meltblown fiber webs, have been widely employed as fine particle filter media since the densely packed fine fibers of these webs provide fine interfiber pore structures that are highly suitable for mechanically trapping or screening fine particles and therefore are conducive for providing a high filter efficiency. However, the fine pore structure of meltblown fiber webs and other similar webs having densely packed fine fibers results in a low permeability. Consequently, the low permeability of fine fiber filter media requires the use of high pressures upstream from the filter in order to establish adequate flow through the filter media. Furthermore, as contaminants accumulate on or in the surface of the filter media, the contaminants quickly clog the small interfiber pores, further reducing the permeability of the media, increasing the pressure drop across the media and rapidly shortening the service-life. In contrast, filter media with large interfiber pores and thus a high permeability, which contain sparsely packed and typically thick fibers, require a relatively low driving pressure to provide an adequate throughput rate.

Other sheet filter media widely used in the industry are cellulosic fiber webs of thermomechanically or chemically processed pulp fibers. Cellulosic fiber media may, for example, be used in automotive oil and fuel filters and vacuum cleaner filters. However, cellulosic fiber filter media tend to have a limited filter efficiency and generally do not provide the high strength properties that is required for high pressure, large volume liquid filtration applications unless the additional step of saturating the paper with a cross-linking agent or polymer is taken, followed by curing the cross-linking agent. An additional disadvantage of existing wet-laid cellulosic filter media is that because they tend to exhibit weak physical properties they are frequently incapable of being pleated and/or sustaining those pleats without the assistance of an additional support layer.

Additionally, the pulp and glass fiber filter media that has been utilized in liquid filtration applications are cellulose and straight glass fibers. The batts of fibers created by this combination are densely packed and result in low permeability, thereby creating a high pressure drop across the material and in some cases even reducing the capacity of the media.

Thus, there remains a need for economical filter media that provide a highly desirable combination of high filtration efficiency, low pressure drop, high capacity and high physical strength without the need to be laminated to a support material or without the need of cross-linking agents. Said another way, there is a need for fluid filter media that provides a combination of desirable filtration properties, including high filtration efficiency, high permeability, low pressure drop, high throughput, long service-life and self-supporting strength.

### SUMMARY OF THE INVENTION

This invention relates generally to a composite which is formed of pulp fibers and glass fibers. Specifically, the present invention provides a composite structure which may be used as a filter medium. One embodiment of the present invention includes pulp fibers and conjugate glass fibers. Desirably, the combination of fibers produces a composite which is softer and has a lower folding endurance than conventional pulp and glass fiber composites. Where it is desirable to be able to pleat the material, the addition of polyester staple fibers to the composite provides sufficient stiffness to achieve and maintain the desired pleating. The pulp fibers which comprise the composite of the present invention are desirably from 100% to about 10%, and more desirably from about 95% to about 20%, softwood fibers and from 0% to about 90%, more desirably from about 5% to about 80%, hardwood fibers. The conjugate fibers of the present invention are desirably oriented in side-by-side or eccentric sheath-core arrangement, and desirably may be crimped. The glass desirably includes at least a positive amount up to about 40% by weight of the composite, and more desirably from about 10% to about 35% by weight. As the addition of the glass fibers has a tendency to result in a web which has lower stiffness and lower folding endurance than a web without the glass fibers, the composite of the present invention may further include polyester fibers, and may optionally also include HDPE, polypropylene, nylon and/or rayon fibers. The addition of polyester fibers to the composite results in a stiffer fabric and provides for, when desired, the increased ability to pleat the material. Desirably, the polyester or other strengthening fibers are present in an amount from 0% to about 35% by weight, and more desirably from about 5% to about 20% by weight, of the composite.

As noted above, the glass fibers are conjugate fibers and are desirably composed of at least two glasses which have different thermal expansion properties. The difference in thermal expansion properties produces a fiber with a random helical crimp. The random helical crimp of the conjugate fibers reduces the packing efficiency of the glass itself and the other fibers. The reduced packing efficiency affords the opportunity to prepare pulp/conjugate glass fiber composite materials with higher porosity and higher permeability for a given basis weight as compared to the traditional cellulose/straight glass fiber composites. Additionally, it has been found that the addition of the polyester staple fibers to the composite lends sufficient stiffness to the web so as to allow pleating without further treatment such as with a binder material. As noted above, the addition of the polyester fibers may also provide sufficient resilience to the web such that the pleats or folds may be maintained. The present invention may further include a strength additive, such as those used commercially and/or those known in the art to be suitable. Dry strength additives which may be suitable for use in the present invention include, but are not limited to, starches (natural and modified), various natural gums, and many synthetic polymers. The strength additives can provide additional strength and/or stiffness to the web to permit pleating and the retention thereof where higher levels of conjugate glass fibers and/or lower amounts of polyester fibers are present in the composite. Desirable strength additives include poly-(acrylamides) (such as AccoStrength® 85 or AccoStrength® 711 (available from Bayer Corporation, having offices in Rock Hill, S.C.)), poly-(acrylates), poly-(amines), poly-(amido-amines), poly-(imines) or the like, such as cationic wet end potato and/or corn starch.

The present invention is also directed to a method of producing a composite. The composite may be useful for filtration. The method of the present invention includes the steps of providing a quantity of pulp fibers, providing a quantity of conjugate glass fibers; and combining the fibers in a wet-laid process so as to produce the composite. The wet-laid process of the present invention may be any suitable wet-laid process capable of producing the desired composite. Any one of the commercially known wet-laid processes may be used, with the exception that those processes should be modified to remove the wet pressing step (i.e. unload or de-load the wet press rolls), such that the composite is not undesirably compacted, thereby allowing the composite of the present invention to maintain the desired porosity and permeability.

The method of the present invention may also include the step of providing a quantity of polyester fibers, wherein the polyester fibers are combined in the wet-laid process to produce the composite. Alternative embodiments of the present invention may also include the step of providing a quantity of fibers selected from the group of materials consisting of HDPE, polypropylene, nylon and rayon. The method may further include the step of providing a strength additive, wherein the strength additive is combined in the wet-laid process. Desirably, the pulp fibers included in the method of the present invention include from 100% to about 10%, more desirably from about 95% to about 20%, softwood fibers and from 0% to about 90%, and more desirably about 5% to about 80%, hardwood fibers. Desirably, a sufficient amount of polyester fibers are provided to the process of the present invention so as to produce a composite which has from 0% to about 35%, and more desirably from about 5% to about 20%, by weight polyester fibers. Desirably, the glass fibers include from a positive amount to about 40%, and more desirably from about 10% to about 35%, by weight of the composite.

The method of the present invention may further include the step of crimping the glass fibers, wherein the crimping provides for an increase in the bulk of the composite and wherein the porosity of the composite is increased. The step of crimping the glass fibers may occur prior to the step of combining the fibers to produce the composite or, alternatively, after the step of combining the fibers.

The method of the present invention may further include the step of folding or pleating the composite. The resulting media will desirably have a higher porosity and enhanced stiffness as compared to traditional non-conjugate and non-crimped cellulose/glass fiber composites.

### BRIEF DESCRIPTION OF THE DRAWINGS

FIG. 1 illustrates an exemplary wet-laid process which may be suitable for use in the present invention.

FIG. 2 illustrates a process suitable for producing the conjugate glass fibers of the present invention.

FIG. 3 illustrates an exemplary configuration of an laminate composite of the present invention, wherein a pulp and conjugate glass fibers composite is laminated to a first and a second meltblown layer.

### DEFINITIONS

As used herein, the term “batting” means a soft, bulky assembly of fibers or foam. Battings are usually sold in sheets or rolls and used for warm interlinings, comforter stuffings, and other thermal applications.

As used herein, the term “biconstituent fibers” refers to fibers which have been formed from at least two polymers extruded from the same extruder as a blend. The term “blend” is defined below. Biconstituent fibers do not have the various polymer components arranged in relatively constant positioned distinct zones across the cross-sectional area of the fiber and the various polymers are usually not continuous along the entire length of the fiber, instead usually forming fibrils or protofibrils which start and end at random. Biconstituent fibers are sometimes also referred to as multiconstituent fibers. Fibers of this general type are discussed in, for example, U.S. Pat. No. 5,108,827 to Gessner. Bicomponent and biconstituent fibers are also discussed in the textbook Polymer Blends and Composites by John A. Manson and Leslie H. Sperling, copyright 1976 by Plenum Press, a division of Plenum Publishing Corporation of New York, IBSN 0-306-30831-2, at pages 273 through 277.

As used herein the term “blend” means a mixture of two or more polymers while the term “alloy” means a sub-class of blends wherein the components are immiscible but have been compatibilized. “Miscibility” and “immiscibility” are defined as blends having negative and positive values, respectively, for the free energy of mixing. Further, “compatibilization” is defined as the process of modifying the interfacial properties of an immiscible polymer blend in order to make an alloy.

As used herein and in the claims, the term “comprising” is inclusive or open-ended and does not exclude additional unrecited elements, compositional components, or method steps.

As used herein, the term “conjugate fibers” refers to fibers which have been formed from at least two polymers extruded from separate extruders but spun together to form one fiber. Conjugate fibers are also sometimes referred to as multicomponent or bicomponent fibers. The polymers are usually different from each other though conjugate fibers may be monocomponent fibers. The polymers are arranged in substantially constant positioned distinct zones across the cross-section of the conjugate fibers and extend continuously along the length of the conjugate fibers. The configuration of such a conjugate fiber may be, for example, a sheath/core arrangement wherein one polymer is surrounded by another or may be a side-by-side arrangement, a pie arrangement or an “islands-in-the-sea” arrangement. Conjugate fibers are taught in U.S. Pat. No. 5,108,820 to Kaneko et al., U.S. Pat. No. 5,336,552 to Strack et al., and U.S. Pat. No. 5,382,400 to Pike et al. For two component fibers, the polymers may be present in ratios of 75/25, 50/50, 25/75 or any other desired ratios. The fibers may also have shapes such as those described in U.S. Pat. No. 5,277,976 to Hogle et al., and U.S. Pat. No. 5,069,970 and 5,057,368 to Largman et al., hereby incorporated by reference in their entirety, which describe fibers with unconventional shapes.

As used herein, the term “Frazier Porosity” refers to the value determined according to the Frazier Porosity Test set forth below.

As used herein, the term “Gurley Porosity” refers to the value determined according to the Gurley Porosity Test set forth below.

As used herein, the term “Gurley Stiffness” refers to the value determined according to the Gurley Stiffness Test set forth below.

As used herein, the term “fluid” means a substance and/or material, including, but not limited to, gas and/or liquid, that flows and can assume the interior shape of a container into which it is poured or placed.

As used herein the term “nonwoven fabric or web” means a web having a structure of individual fibers or threads which are interlaid, but not in an identifiable manner as in a knitted fabric. Nonwoven fabrics or webs have been formed from many processes such as for example, meltblowing processes, spunbonding processes, and bonded carded web processes. The basis weight of nonwoven fabrics is usually expressed in ounces of material per square yard (osy) or grams per square meter (gsm) and the fiber diameters are usually expressed in microns. (Note that to convert from osy to gsm, multiply osy by 33.91).

As used herein, the term “machine direction” or MD means the length of a web in the direction in which it is produced, that is the length parallel to the direction of the machine. The term “cross machine direction” or CD means the width of web, i.e. a direction generally perpendicular to the MD.

As used herein the term “meltblown fibers” means fibers formed by extruding a molten thermoplastic material through a plurality of fine, usually circular, die capillaries as molten threads or filaments into converging high velocity, usually hot gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin. Meltblown fibers are microfibers which may be continuous or discontinuous, are generally smaller than 10 microns in average diameter (using a sample size of at least 10), and are generally tacky when deposited onto a collecting surface.

As used herein the term “microfibers” means small diameter fibers having an average diameter not greater than about 75 microns, for example, having an average diameter of from about 0.5 microns to about 50 microns, or more particularly, microfibers may have an average diameter of from about 2 microns to about 40 microns. Another frequently used expression of fiber diameter is denier, which is defined as grams per 9000 meters of a fiber and may be calculated as fiber diameter in microns squared, multiplied by the density in grams/cc, multiplied by 0.00707. A lower denier indicates a finer fiber and a higher denier indicates a thicker or heavier fiber. For example, the diameter of a polypropylene fiber given as 15 microns may be converted to denier by squaring, multiplying the result by 0.89 g/cc and multiplying by 0.00707. Thus, a 15 micron polypropylene fiber has a denier of about 1.42 (15²×0.89×0.00707=1.415). Outside the United States the unit of measurement is more commonly the “tex”, which is defined as the grams per kilometer of fiber. Tex may be calculated as denier/9.

As used herein the term “monocomponent” fiber refers to a fiber formed from one or more extruders using only one polymer. This is not meant to exclude fibers formed from one polymer to which small amounts of additives have been added for coloration, anti-static properties, lubrication, hydrophilicity, etc. These additives, e.g. titanium dioxide for color, are generally present in an amount less than 5 weight percent and more typically about 2 weight percent.

As used herein the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include but are not limited to isotactic, syndiotactic and random symmetries.

As used herein the term “spunbonded fibers” refers to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,602,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al. Spunbond fibers are generally not tacky when they are deposited onto a collecting surface. Spunbond fibers are generally continuous and have average diameters (using a sample size of at least 10) larger than 7 microns, more particularly, between about 10 and 20 microns.

### DETAILED DESCRIPTION OF THE INVENTION

This invention relates generally to a composite which is formed of pulp fibers and conjugate glass fibers. More specifically, the present invention provides a composite which may be used as a component of or as a filter medium, for the filtration of fluids, including, but not limited to liquid, air and/or other gases and the like. The composite of the present invention includes pulp fibers and conjugate glass fibers. Although any number of types of pulp fibers may used in the present invention, the pulp fibers which comprise the composite of the present invention are desirably from 100% to about 10%, and more desirably from about 95% to about 20%, softwood fibers and from 0% to about 85%, more desirably from about 5% to about 80%, hardwood fibers. Any suitable pulp (including, but not limited to, for example, cellulose or cellulosic material) may be used in the present invention, however, one skilled in the art will recognize that the use of different pulps will result in different composite behavior. Accordingly, the use of certain pulps may be more or less desirable because of their filtration properties, including, but not limited to, porosity, pressure drop, filtration efficiency and stiffness. Pulps which are desirable for use in the present invention include, but are not limited to, woody pulps, such as softwoods or hardwoods; treated wood pulps such as mercerized softwood; and non-woody pulps such as cotton, flax, hemp, bagasse or the like. The glass fibers desirably include at least a positive amount up to about 40% by weight of the composite, and more desirably from about 10% to about 35% by weight of the composite.

Suitable conjugate fibers for the present invention may include, but are not limited to, a side-by-side, segmented pie, islands-in-the sea or sheath-core configuration. When a sheath-core configuration is utilized, an eccentric sheath-core configuration, i.e., non-concentrically aligned sheath and core, is more desirable since eccentric sheath-core fibers are more amenable to thermal crimping processes. Suitable conjugate fibers can be produced with any known staple or continuous conjugate fiber forming process, for example, disclosed in U.S. Pat. No. 3,423,266 to Davies et al., U.S. Pat. No. Reissue 30,955 to Stanistreet, U.S. Pat. No. 4,189,338 to Ejima et al. and commonly assigned European Patent Application 0 586 924. As is known in the art, crimps in conjugate fibers can be imparted before, during or after the fibers are deposited or laid to form a web. However, it is highly desirable to crimp the conjugate fibers before they are formed into a web since the crimping process inherently causes shrinkage and dimensional changes. It is to be noted that although the present invention is illustrated with thermal crimping processes, any known mechanical crimping process can also be utilized.

Generally the combination of fibers of the present invention produces a composite which is softer and has a lower stiffness. The resulting material will typically have a lower folding endurance, thereby making it more difficult to maintain or sustain a pleat or fold generated in the composite. Where it is desirable to be able to pleat the material, the addition of polyester staple fibers (or other strengthening fibers such as HDPE, polypropylene, nylon and/or rayon fibers) to the composite can provide sufficient stiffness, and if desired the ability to achieve and maintain the desired pleating, if any. Accordingly, the composite of the present invention may further include polyester fibers. Desirably, the polyester is present in an amount from 0% to about 35% by weight of the composite, and more desirably from about 5% to about 20%.

As noted above, the glass fibers are conjugate fibers and are desirably composed of at least two glasses which have different thermal expansion properties. The difference in thermal expansion properties produces a fiber with a random helical crimp. The random helical crimp of the conjugate fibers reduces the packing efficiency of the glass itself and the other fibers. The reduced packing efficiency affords the opportunity to prepare pulp/conjugate glass fiber composite materials with higher porosity and higher permeability for a given basis weight as compared to the traditional cellulose/straight glass fiber composites. Additionally, it has been found that the addition of the polyester staple fibers to the composite lends sufficient stiffness to the web so as to allow pleating without further treatment such as with a binder material. The addition of the polyester fibers may also provide sufficient resilience to the web such that the pleats or folds may be maintained. The present invention may further include a strength additive which can provide additional strength and/or stiffness to the web so as to permit pleating and the retention thereof where higher levels of conjugate glass fibers and/or lower amounts of polyester fibers are present in the composite. Suitable strength additives include, but are not limited to poly-(acrylates), poly-(acrylamides), poly-(amines), poly-(amido-amines), poly-(imines) or cationic starch.

The present invention is also directed to a method of producing a composite. More specifically, this invention is directed to a method of producing a composite useful for filtration media having improved stiffness, porosity and permeability. The invention incorporates a wet-laid web containing, at least in part, pulp and conjugate glass fibers. Desirably, the web also includes polyester stable fibers, but may also include fibers consisting of HDPE, polypropylene, nylon and/or rayon. It has been demonstrated that the addition of both conjugate glass fibers and polyester fibers result in a web with increased permeability and stiffness, both of which are desirable characteristics in, for example, an air filtration media. It is contemplated that the glass fibers may also be surface treated with polyelectrolyte polymers or coupling agents either before or after forming. Materials which are suitable for the surface treatment of the glass fibers will depend to some extent on the composition of the glass fibers; however, generally suitable materials include, but are not limited to, poly-(acrylates), poly-(acrylamides), poly-(amines), poly-(amido-amines), poly-(imines), styrene butadiene, phenolic resins and the like. Suitable coupling agents should include functionalized silanes, titanates, and zirconates.

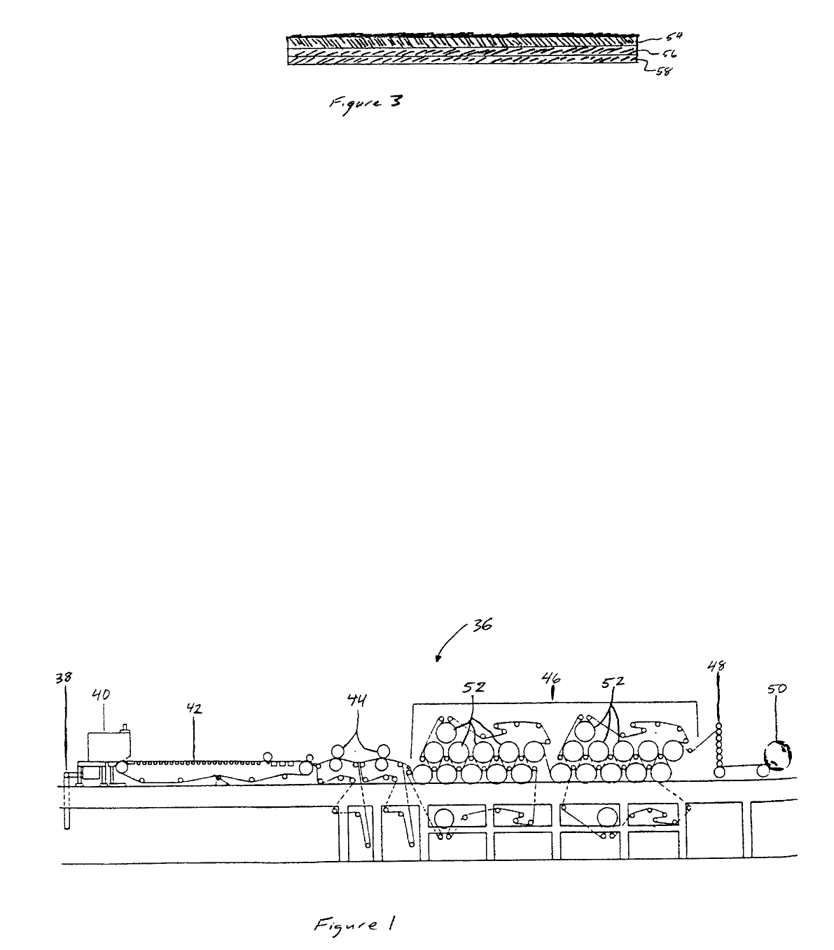

More specifically still, the method of the present invention includes the steps of providing a quantity of pulp fibers, providing a quantity of conjugate glass fibers; and combining the fibers in a wet-laid process so as to produce the composite. The wet-laid process of the present invention may be any suitable wet-laid process which is capable of producing the desired composite. Any one of the commercially known wet-laid processes may be used, with the exception that those processes should be modified to remove the wet pressing step or unload or de-load the rollers typically present in the press section of the process, such that the composite is not undesirably compacted, thereby allowing the composite of the present invention to maintain the desired porosity and permeability. FIG. 1 is a schematic illustration of one operating line suitable for use in producing composite of the present invention.

The method of the present invention may also include the step of providing a quantity of polyester fibers, wherein the polyester fibers are combined in the wet-laid process to produce the composite. The method may also further include the step of providing a strength additive, wherein the strength additive is combined in the wet-laid process. Desirably, the pulp fibers included in the method of the present invention include from 100% to about 10%, more desirably from about 95% to about 20%, softwood fibers and from 0% to about 80%, and more desirably about 5% to about 80%, hardwood fibers. Desirably, a sufficient amount of polyester fibers are provided to the process of the present invention so as to produce a composite which has from 0% to about 35%, and more desirably from about 5% to about 20%, by weight polyester fibers. Desirably the polyester fibers will have a length of about ½ inch. As the polyester fibers do not bind with the cellulose, the inclusion of too much polyester fiber can lead to less bonding within the composite thereby making it more difficult for the composite to maintain its strength and processability in the machines. Additionally, the inclusion of too many polyester fibers or too many fibers having a certain length can lead the polyester fibers to rope and not be dispersed throughout the sheet as desired, thereby resulting in a sheet which does not exhibit the desired characteristics throughout and which may not be suitable for processing. On the other hand, the reduced binding which is experienced because of the inclusion of polyester fibers in the composite, generally opens up the composite resulting in an increase in porosity and a reduction in the pressure drop.

The method of the present invention may further include the step of folding or pleating the composite. The resulting media will desirably have a higher porosity and enhanced stiffness as compared to traditional non-conjugate and non-crimped cellulose/glass fiber composites.

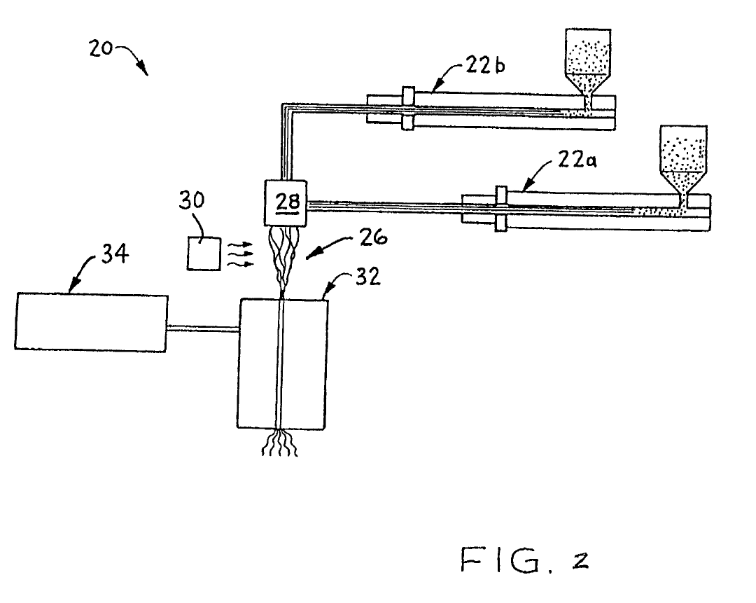

As noted above, the method of the present invention may further include the step of crimping the glass fibers. The step of crimping the glass fibers typically results in or provides for an increase in the bulk of the composite, thereby resulting in an increase of the porosity of the composite. The step of crimping the glass fibers may occur prior to the step of combining the fibers to produce the composite or, alternatively, after the step of combining the fibers. Desirably, the glass fibers include from a positive amount to about 40%, and more desirably from about 10% to about 35%, by weight of the composite. Although not shown as part of FIG. 1 (discussed below), a suitable process for producing the conjugate glass fibers of the present invention is illustrated in FIG. 2, and discussed herein below.

As one skilled in the art will appreciate that the density of the web or tightness or spacing of the fibers of the web will be affected by the degree of crimping the conjugate glass fibers experience. Thus, where desired, one skilled in the art may control the extent or degree of crimping of the conjugate fibers through the careful selection of glass polymers having specific melt ranges, by creating conjugate fibers having certain fiber orientations (e.g. side-by-side arrangement, pie arrangement, sheath/core arrangement, “islands-in-the-sea” arrangement) and/or by manipulating the process conditions, for example the quench temperature and/or quench time, to which the fibers are subjected. Furthermore, as discussed above, the components of the glass fibers may be selected based on desired product characteristics, and it should also be apparent that components should be selected based on the intended or desired processing conditions as well. It is also contemplated that an alternative embodiment of the method of the present invention may further include the step of providing a quantity of fibers, wherein the quantity of fibers are selected from the group of materials of HDPE, polypropylene, nylon and rayon, wherein the fibers are combined in the wet-laid process to produce the composite.

Turning to FIG. 1, there is illustrated a particularly suitable process for producing a composite of the present invention. The exemplary process line 36 is a basic Fourdrinier-type machine (available from Metso Paper, having offices in Boston, Mass.) and includes a flow spreader 38, a headbox 40, forming fabric 42, roll presses 44, a dryer section 46, a calender stack 48, and a reel 50. Generally, the flow spreader 38 takes the incoming pipeline stock flow and distributes it evenly across the machine from side to side. The pressurized headbox 40 discharges a uniform jet of papermaking stock onto the moving fabric 42 of the fourdrinier table. The endless, moving fourdrinier fabric forms the fibers into a continuous matted web while the fourdrinier table 42 drains the water, typically by suction forces (not shown). The sheet of material of the present invention is then passed through the portion of the fourdrinier-type machine where a series of roll presses 44 are present. Although the typical wet-laid process would utilize these presses to remove additional water from the sheet and to consolidate the web structure (i.e. the fibers are forced into intimate contact), in the present invention the roll presses will not engage with pressure or come in contact with the web (i.e. the roll presses will be unloaded/de-loaded), as it is undesirable to compress the web and thereby reduce the porosity and permeability obtained through the use of the conjugate glass fibers. After the web is passed through the portion of the machine in which the roll presses are normally activated, the web passes into a dryer section 46 where most of the remaining water is evaporated and pulp fiber-to-fiber bonds are developed as the web contacts a series of steam-heated cylinders 52 in the dryer section 46. As noted herein the polyester fibers and the cellulose fibers generally do not bond to one another, hence one of the reasons that the addition of too much polyester may be disadvantageous. Once the web passes through the dryer section, the web may, although it is generally undesired in the present invention, be passed through a series of roll nips 48 to reduce the thickness and to smooth the surface of the web. Finally, the dried, and optionally calendered, sheet is accumulated by winding onto a reel 50. One skilled in the art will recognize that the fourdrinier machine, as described, is a general design which may be suitable for a wide range of products and grades thereof. One skilled in the art will also recognize that many variations, modifications, and on-machine operations have been and may be developed for the production of certain products and grades, and that the description of this machine is not intended in any way to limit the scope of the present invention. An example of one of many such possible variations is the inclusion of multiple headboxes which may contain different components, such as pulp, conjugate glass fibers, polyester and the like, and which may be controlled such that the desired amounts of each are released at the desired times so as to produce a web or composite having a desired composition.

Turning to FIG. 2, there is illustrated a particularly suitable process 20 for producing a highly suitable conjugate fiber for the present filter media. The process line 20 includes a pair of extruders 22a and 22b for separately supplying extruded polymer or glass components, a high melting polymer and a low melting polymer, to a bicomponent spinneret 28, although it is contemplated that the fibers may be comprised of only one polymer component (but which exhibits different characteristics (e.g. melting point, crystallinity, etc.)). The spinneret 28 has openings arranged in one or more rows, and the openings form a downwardly extending curtain of fibers when the polymers are extruded through the spinneret.

The line 20 may further include a quenching gas outlet 30 adjacently positioned to the curtain of fibers 26 extending from the spinneret 28, and the gas from the outlet 30 at least partially quenches, i.e., the polymer forming the fibers is no longer able to freely flow. As an example, an air stream of a temperature between about 45° F. and about 90° F. which is directed substantially perpendicular to the length of the fibers at a velocity from about 100 to about 400 feet per minute can be effectively used as a quenching gas. Although the quenching process is illustrated with a one-outlet quenching system, more than one quenching gas outlet can be utilized.

A fiber draw unit or an aspirator 32 is positioned below the quenching gas outlet and receives the quenched fibers. Fiber draw units or aspirators for use in melt spinning polymers are known in the art, and exemplary fiber draw units suitable for the present invention include a linear fiber aspirator of the type shown in U.S. Pat. No. 3,802,817 to Matsuki et al. and eductive guns of the type shown in U.S. Pat. Nos. 3,692,618 to Dorshner et al. and U.S. Pat. No. 3,423,266 to Davies et al. The fiber draw unit 32, in general, has an elongated passage through which the fibers are drawn by aspirating gas. The aspirating gas may be any gas, such as air, that does not adversely interact with the polymers of the fibers. In one embodiment of the present invention, the aspirating gas may be heated using, for example, a temperature adjustable heater 34. The heated aspirating gas draws the quenched fibers and heats the fibers to a temperature that is required to activate the latent crimps therein. The temperature required to activate the latent crimp on the fibers ranges from about 110° F. to a maximum of less than the melting point of the low melting component polymer. Generally, a higher air temperature produces a higher number of crimps per linear measure of fibers. One of the advantages of the fiber web forming process described herein is that the crimp density, i.e., the number of crimps per unit length of a fiber, of the fibers and thus the density and pore size distribution of the resulting webs can be controlled by controlling the temperature of the aspirating gas, providing a convenient way to engineer webs to accommodate different needs of different filter applications. The crimp density can also be controlled to some degree by regulating the amount of potential latent crimps that can be heat activated, and the amount of potential latent crimps can be controlled by varying the spinning conditions, e.g., melt temperature and aspirating gas velocity. For example, higher amounts of potential latent crimps can be imparted on bicomponent conjugate fibers by supplying lower velocities of aspirating gas. Such a process is disclosed, for example, in U.S. Pat. Nos. 5,382,400 and 5,418,045 to Pike et al. As noted above, the fibers need not undergo the additional crimping step, but for ease of discussion purposes below, it is presumed that the fibers are subjected to the heat activated crimping step.

The drawn crimped fibers are then cut by any known means so as to produce fibers which are desirably from about 6 to about 10 millimeters in length. Once cut the fibers may be collected and stored until ready for use. In one embodiment of the present invention, when ready for use, the cut glass fibers are placed in a dispersion bath with an aqueous fluid to produce a slurry desirably including about 3 to about 5% glass fiber. The slurry of glass fibers and aqueous fluid are then added to the solution being supplied to the foraminous surface of the wet-laid process.

The present invention also contemplates the use of multiple layers of the composite described herein to produce a laminate. The resulting laminate would need to be prepared in at least a two-step process (i.e. a first step to prepare the first layer and a second step to prepare a second layer, etc.). The resulting laminate may, but need not, be made of the same composite. That is, the laminate may have a first layer having one composition of pulp, glass fibers, optionally polyester and/or a strengthening agent or additive, and the second or more layers of the composite may have a different composition made of pulp, glass fibers, optionally polyester and/or a strengthening agent or additive. Furthermore, it is contemplated that each layer of a laminate may differ by one or more component. That is, the first layer may include a first type of pulp and the second layer may include the same or a different type of pulp and/or may be present in differing amounts. Furthermore, the components of the conjugate fibers may vary from layer to layer. One skilled in the art will recognize that any number of variations between the layers is possible and are intended to be included within the scope of the present invention. It is of note that by varying the degree of crimp from layer to layer of the composite or fabric, the resulting fabric may have a density or pore size gradient for improved fluid handling properties. For example, a multilayer fabric can be made such that the outer layer has relatively large pore sizes while the inner layer has small pore sizes so that liquid is drawn by capillary action through the more porous outer layer into the more dense inner layer. In addition, polymer type and filament denier may be altered from layer to layer to affect the fluid handling properties of the composite web.

In addition to laminates formed of multiple layers of pulp and conjugate glass fibers, it is also contemplated that laminates may be formed of one or more layers of pulp and conjugate glass fibers and one or more layers of a melt spun product. More specifically, it is envisioned that one or more layers of the pulp and conjugate fiber composite could be laminated to one or more layers of a meltblown web. The pulp/glass layer or layers will provide support to the composite, and the meltblown layer or layers of the laminate will increase the filtration efficiency of the resulting composite. The pulp and glass composite can be combined with the meltblown layers so as to create a media having gradient filtration properties. An exemplary configuration of the laminate discussed above is illustrated in FIG. 3, wherein the pulp and conjugate glass fibers composite 54 is laminated to a first meltblown layer 56, desirably polypropylene or polyethylene, and a second meltblown layer 58, also desirably polypropylene or polyethylene, is laminated to the first meltblown layer 56. It is contemplated that the meltblown layer or layers may be formed of either fine or course fibers, or a combination thereof. That is, as is known to one skilled in the art, a meltblown layer or web can itself consist of multiple layers formed by multiple banks, and the characteristics of these multiple layers can be uniform or they may be varied. Such a process is disclosed, for example, in U.S. Pat. No. 4,455,068 to Win et al.

In addition, the composite or its components may further contain minor amounts of additives or other fibers known to enhance the performance of the composite. For example, the composite may contain compatibilizing agents, colorants, pigments, optical brighteners, ultraviolet light stabilizers, antistatic agents, lubricants, abrasion resistance enhancing agents, crimp inducing agents, nucleating agents, fillers and other processing aids.

### Test Methods

Frazier Porosity Test

The Frazier Porosity values referred to in the present specification can be determined employing a Frazier Air Permeability Tester (Frazier Precision Instrument Co., Gaithersburg, Md.) and Method 5450, Federal Test Methods Standard No. 191A. For the purposes of the present invention, the test is conducted with a sample which measures 8 inches by 8 inches and measures the air flow rate through a web in cubic feet of air per square foot of web per minute or CFM. Convert CFM to liters per square meter per minute (LSM) by multiplying CFM by 304.8

Gurley Porosity Test

The Gurley Porosity values referred to in the present specification can be determined employing a Gurley-Hill Softness-Porosity-Smoothness tester (serial number NL0004) (available from Gurley Precision Instruments in Troy, N.Y.) and TAPPI Test Method No. T-460-OM-96 (1996). However, rather than measuring the air flow rate of air through the test web in cubic feet of air per square foot of web per minute as in the Frazier Porosity Test, discussed above, the Gurley Porosity Test measures the amount of time it takes for a certain volume of air to pass through the media. Generally, the test is run to determine the time taken for 100 cc of air to pass through the media sample, thus the Gurley Porosity is frequently expressed in the units of seconds/100 cc of air.

Gurley Stiffness Test

For the purposes of the present invention, the various rigidity stiffness values are determined with respect to a bending moment produced by a force which is directed perpendicular to the plane substantially defined by the length and width of the component being tested. A suitable technique for determining the rigidity, stiffness values described herein is a Gurley Stiffness test, a description of which is set forth in TAPPI Standard Test T 543 om-00 (Stiffness of paper (Gurley type stiffness tester)). A suitable testing apparatus is a Gurley Digital Stiffness Tester; Model 4171-D manufactured by Teledyne Gurley (514 Fulton Street, Troy, N.Y. 12181-0088). This instrument allows the testing of a wide variety of materials through the use of various lengths and widths in combination with the use of a 5, 25, 50, or 200 gram weight placed in one of three positions on the pointer of the apparatus. For purposes of the present description, the stated Gurley stiffness values are intended to correspond to the values that would be generated by a “standard” sized sample. Accordingly, the scale readings from the Gurley stiffness tester are appropriately converted to the stiffness of a standard size sample and are expressed in terms of milligrams. The standard size sample has a width of 1″ and a nominal length of 3″ (actual length of 3.5″). The actual length of the sample is the nominal length, plus an additional 0.25″ of length for holding in the clamp and another 0.25″ of length for overlapping the vane. Tables of factors for taking scale readings generated with non-standard sized test samples and converting the readings to the stiffness of the standard size sample are given in the Instruction Manual for the Gurley Stiffness Tester provided by Teledyne Gurley. Accordingly, other designated dimensions for the test sample may also be conveniently employed, so long as the appropriate conversion factor is employed to determine the appropriate value which corresponds to the standard size sample.

Preparation of Wet-laid Handsheets

In each of the Examples discussed below, the handsheets were prepared according to the following procedures.

Preparation of wet-laid handsheets including glass fibers

The pulp fibers were prepared by refining with a laboratory Valley beater (1.5 pound cast bronze) (available from Voith, Inc., having offices in Appleton, Wis.). The refined pulp was diluted to an approximate consistency of 1.7%. The glass fiber was added at a rate of 20% glass fiber based on the total dry fiber weight. The glass fiber was added batchwise to the diluted pulp slurry with mixing in a Waring blender (available from Dynamics Corporation of America, having offices in New Hartford, Conn.). After combining the glass and pulp fiber, the pH was adjusted to about 5.0 with hydrochloric acid (HCl). Parez® 607, a wet-strength resin (available from Cytec Industries Inc., having offices in West Paterson, N.J.) was added at 0.3% on dry fiber rate and Aquapel® 752 (an alkyl ketene dimer emulsion—used as sizing agent) (available from Hercules Incorporated, having offices in Wilmington, Del.) was added at 1.9% on dry fiber rate. The appropriate volume of slurry to produce a handsheet with a target basis weight of 37 gsm was added to the former. The slurry in the former was further diluted and mixed manually to improve formation. The water was then drained from the former and the fibrous web was removed from the screen. The web was pressed at approximately 200 psi for 5 minutes. After pressing, the handsheet was dried upon a steam heated cylinder at 220-240° F. surface temperature.

Procedure for making handsheets with polyester and glass fibers

The pulp fibers were prepared by refining with a laboratory Valley beater. Measured quantity of polyester fibers initially dispersed in water was added slowly to the pulp in the valley beater. The refined pulp was diluted to an approximate consistency of 1.7%. The glass fiber was added at a rate of 20% glass fiber based on the total dry fiber weight. The glass fiber was added batchwise to the diluted pulp slurry with mixing in a Waring blender. The appropriate volume of slurry to produce a handsheet with a target basis weight of 37 gsm was added to the former. The slurry in the former was further diluted and mixed manually to improve formation. The water was then drained from the former and the fibrous web was removed from the screen using blotting paper. The web was pressed very lightly with blotting paper covering the sheets. After pressing, the handsheet was dried upon a steam heated cylinder at 220-240° F. surface temperature.

It is of note that each of the methods for preparing handsheets described above includes a step of pressing the web under pressure. While, as noted above, it is generally undesirable to press the web of the present invention in the production thereof as it tends to compress or densify the web thereby reducing the bulk, porosity and permeability of the web, in order to prepare the handsheets on the small scale conditions pressure was used to facilitate the removal of excess material from the web where a vacuum or suction means and gravity would generally be used in the wet-laid processes of the present invention.

### EXAMPLES

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Example 1

A number of handsheets containing up to 30% MIRAFLEX™ glass fiber, a side-by-side conjugate glass fiber (available from Owens Corning, having offices in Toledo, Ohio) were prepared and tested. The handsheets were created with the intention to test the feasibility of using MIRAFLEX™ glass fiber, in a wet-laid application. Sheets containing 87% bleached N. softwood kraft fiber (LL19, available from Kimberly-Clark Corporation) and 13% MIRAFLEX™ glass fiber with a K12 finish (available from Owens Corning) were made and compared to sheets containing 100% LL19.

The addition of MIRAFLEX™ glass fiber to the slurry did not negatively affect the formation of the sheet and seemed to disperse easily in the pulp slurry. Porosity testing demonstrated the true benefits of the new fiber in a cellulose web. The 8 ply Gurley porosity of the 100% LL19 sheet was 8.4 sec/100 cc; the 8 ply Gurley porosity of the sheet containing the glass fiber was 2.9 sec/100 cc. Similarly, the Frazier porosity of the 100% LL19 sheet was 3.95 cfm; the Frazier porosity of the 13% glass sheet was 9.76 cfm.

The media made in Example 1 was determined to be suitable for a wide variety of filtration composites, and has been specifically identified to be useful as diesel fuel filter media. Additional work demonstrated the ability to readily control the porosity of the web with the addition of MIRAFLEX™ glass fiber, and showed its suitability as a filtration device.

### Example 2

In order to develop material with better pleating characteristics additional work exploring the use of polyester fiber as a means of stiffening the web was performed. At the time of testing, the filter media or composite was contemplated for use in air filtration, although other uses were recognized. Handsheets were prepared and tested containing 0% and 30% MIRAFLEX™ glass fiber and 0% and 10% polyester staple fiber (6 dpf ½″). The sheets containing polyester fiber had 73% more stiffness than sheets without polyester fiber. Sheets containing both MIRAFLEX™ glass fiber and polyester fiber had 42% increased stiffness. Sheets with glass fiber and polyester fiber had 33% lower pressure drop versus 100% cellulose or cellulose sheets with 10% polyester fiber. Thus the addition of both MIRAFLEX™ glass fiber and polyester fiber resulted in a web with increased permeability and stiffness, both desirable characteristics in an air filtration media.

### Example 3

While the use of straight glass fiber in cellulose webs was first documented in the 1950's, the present invention provides the unique ability to control sheet porosity which has not been previously demonstrated by other synthetic fibers and cellulose sheets.

A comparison of a handsheet of the present invention was made to sheets containing staple high density and 10% poly(ethylene terephthalate) (PET) staple fiber and sheets containing standard straight E glass fibers (available from PPG, having offices in Pittsburgh, Pa.) of similar dimensions. The results shown in Table 1 were compiled from work related to a polymer impregnated filter, wherein the polymer used was Hycar® 26769 (an alkylphenol ethoxylate-free version of Hycar® 26469) (available from Noveon, Inc., having offices in Cleveland, Ohio).

TABLE 1

| | Synthetic | Polymer | Basis | Frazier |
|---|---|---|---|---|
| Pulp | Furnish | Add-on (% | Weight | Porosity |
| Furnish (wt. %) | (wt. %) | dry pickup) | (gsm) | (cfm) |
| 40% bleached | 20% | 40 | 59.9 | 54.7 |
| eucalyptus, 12% N. | MIRAFLEX ™ | | | |
| bleached softwood | glass fiber | | | |
| kraft (LL19), | | | | |
| 28% mercerized | | | | |
| softwood | | | | |
| 40% bleached | 20% DeltaChop | 42 | 68.6 | 32.3 |
| eucalyptus, 12% N. | 8610 straight | | | |
| bleached softwood | E glass fiber | | | |
| kraft (LL19), | | | | |
| 28% mercerized | | | | |
| softwood | | | | |
| 52% bleached | 20% HDPET | 40 | 60.3 | 37.8 |
| eucalyptus, 28% | fiber | | | |
| mercerized | | | | |
| softwood | | | | |

### Example 4

Additional developmental work was performed in the area of diesel fuel filters. The initial design consisted of 51% eucalyptus fiber (available from Votorantim Celulose e Papel, having an office in Newark, Del.), 34% bleached N. softwood kraft fiber (LL19), and 15% MIRAFLEX™ glass fiber. The pulp was refined to a tensile sum of 0.45 before the glass fiber was added. The 8 ply Gurley porosity of the sample was 11.6 sec/100 cc; Frazier porosity was 2.58 cfm. Increasing the glass fiber content to 20% resulted in a Gurley porosity of 7.8 sec/100 cc and a Frazier porosity of 3.4 cfm. For comparison, a sheet containing 0% glass, 60% eucalyptus fiber, and 40% LL19 had a Gurley porosity of 26.2 sec/100 cc (8 ply) and a Frazier porosity of 1.22 cfm.

### Example 5

In view of the results of Example 4, pulp and conjugate fiber handsheets incorporating polyester fiber were produced for the design of air filtration media. The composition of the three different handsheet designs and the results of the tests performed thereon are given in Table 2 below.

TABLE 2

| Design | I | II | III |
|---|---|---|---|
| Southern Softwood (Leaf River) | 25 | 22.7 | 17.9 |
| (% by weight of composite) | | | |
| Hardwood (Eucalyptus) (% by | 75 | 68.2 | 53.6 |
| weight of composite) | | | |
| Glass Fiber (MIRAFLEX ™ glass | 0 | 0 | 21.4 |
| fiber) (% by weight of composite) | | | |
| Polyester Fiber (6 dpf ½″) (% by | 0 | 9.1 | 7.1 |
| weight of composite) | | | |
| Delta P mm H₂O | 5.1 | 5.1 | 3.4 |
| Efficiency % | 42.2 | 48.0 | 32.3 |
| Basis Wt. (gsm) | 70.3 | 77.4 | 86.8 |
| Caliper mils | 12 | 13 | 15 |
| Frazier Porosity | 28 | 27 | 38 |
| Stiffness | 142 | 246 | 202 |

While the present invention has been described in connection with certain desired embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

It should further be noted that any patents, applications or publications referred to herein are incorporated by reference in their entirety.

What is claimed is:

1. A composite comprising:
pulp fibers; and
conjugate glass fibers.

2. The composite of claim 1, wherein the pulp fibers of the composite comprise from 100% to about 10% softwood fibers and from 0% to about 90% hardwood fibers.

3. The composite of claim 1, wherein the glass fibers comprise from a positive amount to about 40% by weight of the composite.

4. The composite of claim 1, wherein the glass fibers comprise from about 10% to about 35% by weight of the composite.

5. The composite of claim 1 further comprising one or more of the group consisting of polyester, HDPE, polypropylene, nylon and rayon.

6. The composite of claim 5, wherein the polyester fiber comprises from 0% to about 35% by weight of the composite.

7. The composite of claim 1, wherein the glass fibers in a configuration selected from the group consisting of sheath/core, islands-in-the-sea, segmented pie, and side-by-side.

8. The composite of claim 1 further being laminated to a nonwoven web.

9. The composite of claim 8, wherein the nonwoven web comprises at least one layer of melt spun material.

10. A filter media comprising:
pulp fibers; and
bicomponent glass fiber, said glass fibers comprised of glasses having different thermal expansion properties such that the glass fibers are capable of crimping.

11. The media of claim 10, wherein the pulp fibers of the media comprises from 100% to about 10% softwood fibers and from 0% to about 90% hardwood fibers.

12. The media of claim 10, wherein the pulp fibers of the media comprises from 95% to about 20% softwood fibers and from about 5% to about 80% hardwood fibers.

13. The media of claim 10, wherein the glass fibers comprise from a positive amount to about 40% by weight of the media.

14. The media of claim 10, wherein the glass fibers comprise from about 10% to about 35% by weight of the media.

15. The media of claim 10, wherein the glass fibers are in a configuration selected from the group consisting of sheath/core, islands-in-the-sea, segmented pie and side-by-side.

16. The media of claim 10 further comprising one or more of the group consisting of polyester, HDPE, polypropylene, nylon and rayon.

17. The media of claim 16, wherein the polyester fiber comprises from 0% to about 35% by weight of the media.

18. The media of claim 16, wherein the polyester fiber comprises from about 5% to about 20% by weight of the media.

19. The media of claim 10, wherein the media further comprises a strength additive.

20. The media of claim 10, wherein the strength additive comprises poly-(acrylates), poly-(acrylamides), poly-(amines), poly-(amido-amines), poly-(imines).

21. The media of claim 10 further being laminated to a nonwoven web.

22. The media of claim 21, wherein the nonwoven web comprises at least one layer of melt spun material.

23. A method of producing a composite, said method comprising:
providing a quantity of pulp fibers;
providing a quantity of conjugate glass fibers;
combining the fibers in a wet-laid process so as to produce the composite.

24. The method of claim 23 further comprising the step of providing a quantity of polyester fibers, wherein the polyester fibers are combined in the wet-laid process to produce the composite.

25. The method of claim 23 further comprising the step of providing a strength additive, wherein the strength additive is combined in the wet-laid process.

26. The method of claim 23 wherein the pulp fibers comprises from 100% to about 10% softwood fibers and from 0% to about 90% hardwood fibers.

27. The method of claim 23 wherein the pulp fibers comprises from 95% to about 20% softwood fibers and from about 5% to about 80% hardwood fibers.

28. The method of claim 23, wherein the method further comprises the step of crimping the glass fibers, wherein the crimping provides for an increase in the bulk of the composite and wherein the porosity of the composite is increased.

29. The method of claim 28, wherein the step of crimping the glass fibers occurs prior to the step of combining the fibers to produce the composite.

30. The method of claim 28, wherein the step of crimping the glass fibers occurs after the fibers are combined.

31. The method of claim 23, wherein the glass fibers are in a configuration selected from the group consisting of sheath/core, islands-in-the-sea, segmented pie, and side-by-side.

32. The method of claim 23, wherein the glass fibers comprise from a positive amount to about 40% by weight of the composite.

33. The method of claim 23, wherein the glass fibers comprise from about 10% to about 35% by weight of the composite.

34. The composite of claim 24, wherein the polyester fiber comprises from 0% to about 35% by weight of the composite.

35. The composite of claim 24, wherein the polyester fiber comprises from about 5% to about 20% by weight of the composite.

36. The method of claim 23, wherein the method further comprises the step of folding or pleating the composite material.

37. The method of claim 23, wherein the composite comprises a filter media product or component thereof.

38. The method of claim 23 further comprising the step of providing a quantity of fibers, wherein the quantity of fibers are selected from the group of material consisting of HDPE, polypropylene, nylon and rayon, wherein the quantity of fibers are combined in the wet-laid process to produce the composite.

39. The method of claim 23 further comprising the steps of:
providing at least a second layer of material; and
laminating the one or more additional layers to the composite;
wherein the composite has increased filtration efficiency.

40. The method of claim 39, wherein the one or more additional layers are selected from a meltspun material or pulp and conjugate glass fibers.
